(19) United States
(12) Patent Application Publication
(10) Pub. No.: US 2013/0055238 A1
(43) Pub. Date: Feb. 28, 2013

(54) SYSTEM AND METHOD FOR PROVIDING VIRUS PROTECTION

(71) Applicants: Seung Hyun LEE, Seoul (KR); Bo Sun KIM, Seoul (KR); Soo Young HUH, Seoul (KR)

(72) Inventors: Seung Hyun LEE, Seoul (KR); Bo Sun KIM, Seoul (KR); Soo Young HUH, Seoul (KR)

(73) Assignee: PANTECH CO., LTD., Seoul (KR)

(21) Appl. No.: 13/341,139

(22) Filed: Dec. 30, 2011

(30) Foreign Application Priority Data
Aug. 25, 2011 (KR) 10-2011-0085008

(51) Int. Cl. G06F 9/445; G06F 17/30; G06F 15/16; G06F 11/00

(52) U.S. Cl. 717/178; 726/24

(57) ABSTRACT

A terminal device may backup data in a cloud server. The cloud server may generate a virtual apparatus to perform substantially the same operations as the terminal device, and may install an application in the virtual apparatus prior to the application being installed in the terminal device, thereby performing a virus check before the application is installed in the terminal device. In addition, the terminal device may store backup data in the cloud server. If the terminal device malfunctions, the terminal device may be restored by receiving the stored backup data from the cloud server.

### CROSS-REFERENCE TO RELATED APPLICATION

This application claims priority from and the benefit of Korean Patent Application No. 10-2011-0085008, filed on Aug. 25, 2011, which is hereby incorporated by reference for all purposes as if fully set forth herein.

### BACKGROUND OF THE INVENTION

1. Field

The present disclosure relates to a system that may backup a terminal device in a cloud server and check for a virus in an application to be installed through the cloud server, thereby providing virus protection to the terminal device.

2. Discussion of the Background

With the development of related technologies and the introduction of the wireless Internet, the use of the mobile terminal has been expanded from a simple telephone call, a to do list, and the like, to taking photographs using an installed digital camera, viewing satellite broadcasts, playing games, surfing the web via wireless Internet, using Bluetooth, listening to the music, an email service, and the like.

In addition to application programs provided by a manufacturer of a mobile terminal, additional programs may be installed in the mobile terminal. It is difficult to verify whether a malicious code or virus is included in an application program before installing the application program. Therefore, an application program with a malicious code or virus may be installed in the mobile terminal.

### SUMMARY OF THE INVENTION

Exemplary embodiments of the present invention provide a method for backing up and restoring mobile terminal data in a cloud server, and restoring a terminal device using the stored backup data if the terminal device malfunctions.

Exemplary embodiments of the present invention also provide a terminal device to transmit, as backup data, data stored in a memory unit of the terminal device to a cloud server, the cloud server to generate a virtual apparatus performing substantially the same operations as the terminal device, and to perform a virus check by installing, in the virtual apparatus, an application program to be installed in the terminal device.

Additional features of the invention will be set forth in the description which follows, and in part will be apparent from the description, or may be learned by practice of the invention.

An exemplary embodiment of the present invention discloses a system to perform a virus check, including: a terminal device to generate backup data corresponding to data stored in the mobile terminal, and to transmit the backup data via a network; and a cloud server to receive the backup data, to generate a virtual terminal device corresponding to the backup data, to perform a virus check of an application using the virtual terminal device, and to generate a virus check result, wherein the cloud server performs the virus check of the application in the virtual terminal device in response to a request from the terminal device and transmits the virus check result to the terminal device.

An exemplary embodiment of the present invention also discloses terminal device, comprising: a backup processing unit to generate backup data corresponding to data stored in the terminal device; an application downloader to download an application; a reliability evaluator to determine reliability of the application; a communication unit to transmit the backup data and a request for a virus check and to receive a virus check result; and an application installer to install the application in response to the reliability evaluator determining the application is reliable or in response to the virus check result

An exemplary embodiment of the present invention also discloses a cloud server, including: a backup processing unit to receive backup data from a terminal; a virtual apparatus processing unit to generate a virtual apparatus corresponding to the backup data; a reliability evaluator to evaluate reliability of an application in response to a request from the terminal; and a virus check unit to determine if a virus exists in the application installed in the virtual apparatus and to transmit a result of the virus check to the terminal.

An exemplary embodiment of the present invention also discloses a method for installing an application in a terminal device, including: generating backup data corresponding to data stored in the terminal device; transmitting the backup data to a cloud server; downloading an application in the terminal device; evaluating reliability of the application in the terminal device; if the application is considered reliable, installing the application; and if the application is not considered reliable: requesting a virus check of the application from a cloud server; performing the virus check of the application in the cloud server; if the virus check determines a virus is present, transmitting the result of the virus check to the terminal; and if the virus check determines a virus check is not present, installing the application in the terminal device.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a system to prevent virus damage according to an exemplary embodiment of the present invention.

FIG. 2 is a block diagram illustrating a terminal device according to an exemplary embodiment of the present invention.

FIG. 3 is a block diagram illustrating a cloud server according to an exemplary embodiment of the present invention.

FIG. 4 is a diagram illustrating a reliability database according to an exemplary embodiment of the present invention.

FIG. 5 is a flowchart illustrating a method for installing an application in a terminal device according to an exemplary embodiment of the present invention.

FIG. 6 is a flowchart illustrating a method for checking whether a virus exists in an application in a cloud server according to an exemplary embodiment of the present invention.

FIG. 7 is a flowchart illustrating a method for backing up and restoring data in a terminal device according to an exemplary embodiment of the present invention.

FIG. 8 is a flowchart illustrating a method for generating reference information according to an exemplary embodiment of the present invention.

FIG. 9 is a block diagram illustrating a terminal device according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

In the specification, an application program, an application, and firmware are each referred to as an application.

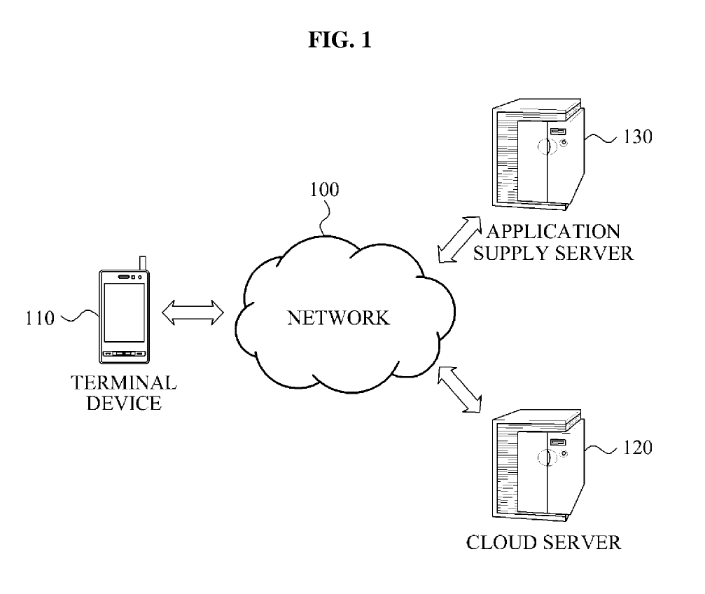

FIG. 1 is a diagram illustrating a system to prevent virus damage according to an exemplary embodiment of the present invention.

Referring to FIG. 1, a system to prevent virus damage may include a terminal device 110, a cloud server 120, and an application supply server 130.

The terminal device 110 may generate, as backup data, all of or a portion of data included in the terminal device 110, and may transmit the backup data to the cloud server 120 over a network 100.

If an issue, such as, a system error, a virus discovery, and the like, occurs, the data backed up from the terminal device 110 may be restored using the backup data transmitted to and stored in the cloud server 120.

The terminal device 110 may request the cloud server 120 for a virus check of an application to be installed on the terminal device 110 before downloading and installing the application from the application supply server 130.

The cloud server 120 may generate a virtual apparatus that operates in substantially the same manner as the terminal device 110, based on the backup data received from the terminal device 110. If a request for a virus check is received from the terminal device 110, the cloud server 120 may download the application from the application supply server 130, install the application, perform the virus check, and provide a virus check result to the terminal device 110.

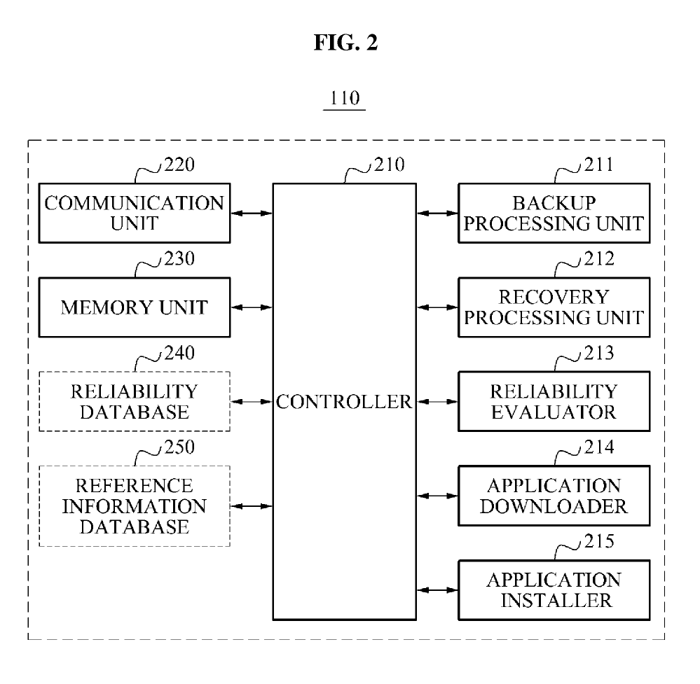

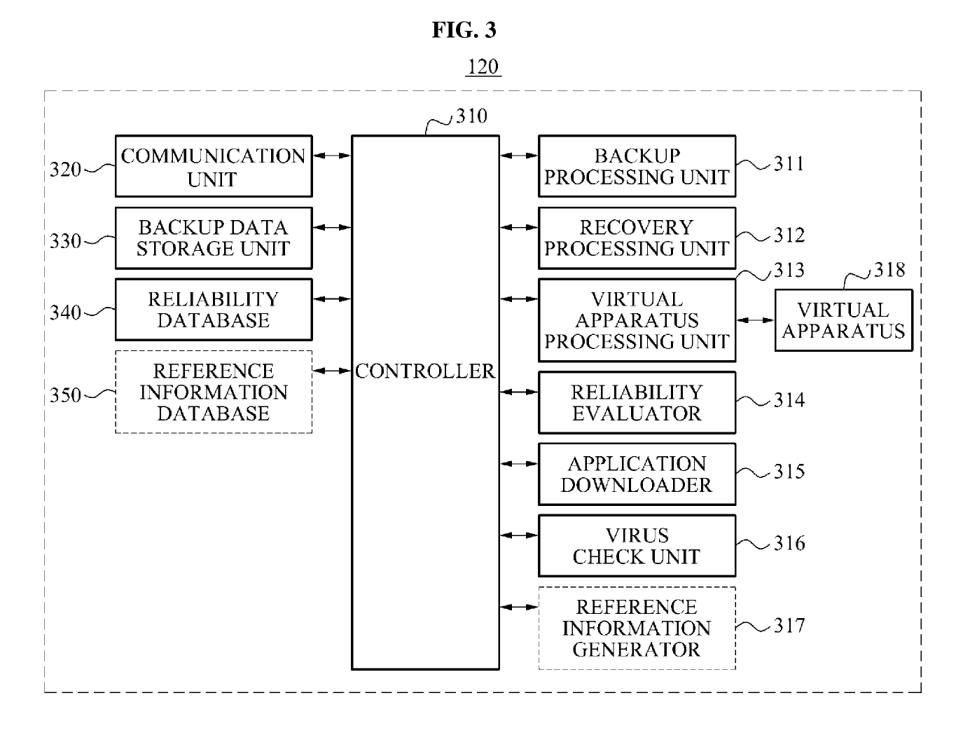

Hereinafter, the terminal device 110 and the cloud server 120 will be described with reference to FIG. 2 and FIG. 3.

FIG. 2 is a block diagram illustrating a terminal device according to an exemplary embodiment of the present invention.

Referring to FIG. 2, the terminal device 110 may include a controller 210, a backup processing unit 211, a recovery processing unit 212, a reliability evaluator 213, an application downloader 214, an application installer 215, a communication unit 220, and a memory unit 230. The terminal device 110 may further include at least one of a reliability database 240 and a reference information database 250.

The communication unit 220 may transmit data to and receive data from the cloud server 120 or the application supply server 130 over a wired/wireless network 100. The communication unit 220 may wireles sly transmit and receive data through a radio communication scheme based on a frequency division multiple access (FDMA), a time division multiple access (TDMA), a space-division multiple access (SDMA), a code division multiple access (CDMA), a wideband code division multiple access (WCDMA), an orthogonal frequency division multiplexing (OFDM), a wireless fidelity (Wi-Fi), a wireless broadband (WiBro®), Bluetooth, infrared (IR) communication, and the like. The communication unit 220 may transmit and receive a radio signal of data that is input and output via an antenna. For example, in the case of the transmission of data, the communication unit 220 may perform channel coding and spreading of data to be transmitted and then perform a radio frequency (RF) processing of the data and transmit the RF processed data. In the case of the reception of data, the communication unit 220 may convert a received RF signal to a baseband signal, perform de-spreading and channel decoding of the baseband signal, and thereby restore data. Since the element of the terminal device 110 that transmits data to and receives data from the cloud server 120 or the application supply server 130 is the communication unit 220, the corresponding description of equivalent units in the cloud server 120 and the application supply server 130 will be omitted in the following description.

The memory unit 230 may store system data associated with an operating system that is used to control an overall operation of the terminal device 110, an installed application, update information of the application, user data, for example, a telephone number, a short message service (SMS) message, a compressed image file, a moving picture, and the like. The memory unit 230 may store backup data that is generated by the backup processing unit 211 or backup data that is received from the cloud server 120.

The reliability database 240 may store information about the reliability of each application. Information about the reliability of each application stored in the reliability database 240 may be provided from the cloud server 120 or a separate server evaluating the reliability of the application.

The reference information database 250 may store reference information, i.e., information used to evaluate the reliability of each application. The reference information stored in the reference information database 250 may be provided from the cloud server 120 or a separate server generating reference information. The reference information may include at least one of a reliable category, a reliable creator, a reliable sales server, a reliable reference release date, and a reliable permission.

For example, if reference information includes a sales server P, applications that are sold through the sales server P may be determined to be reliable. If reference information includes a creator A, an application created by the creator A may be determined to be reliable. If reference information includes a combination of the sales server P and the creator A, an application that is created by the creator A and is sold through the sales server P may be determined to be reliable.

The backup processing unit 211 may generate, as backup data, all of or a portion of data stored in the memory unit 230, and may transmit the backup data to the cloud server 120. The backup data may include a time stamp indicating a creation time.

In an initial stage, the backup processing unit 211 may generate, as backup data, all data stored in the memory unit 230, and may transmit the backup data to the cloud server 120. Next, the backup processing unit 211 may generate updated data by compressing changed or added data and then transmit the updated data to the cloud server 120.

The backup processing unit 211 may generate backup data including data that is used if the cloud server 120 generates a virtual apparatus capable of performing substantially the same operations as the terminal device 120. For example, the data used if the cloud server 120 generates the virtual apparatus may include system data, an installed application, and updated information of the application, and may further include user data, for example, a telephone number, an SMS message, a compressed image file, a moving picture, and the like.

When generating backup data, the backup processing unit 211 may generate the backup data by reading data stored in the memory unit 230 based on a block unit and compressing the read data.

When the occurrence of an update event is detected, the backup processing unit 211 may generate updated data and transmit the updated data to the cloud server 120. The updated data may include a time stamp indicating a creation time.

The backup processing unit 211 may generate updated data by compressing changed or added data, and may generate updated data by compressing a changed block of the memory unit 230 based on a block unit. If generating the updated data based on the block unit, changed data and unchanged data may be included within a single block. For example, even the unchanged data is compressed and thus, system resources may be wasted. However, by using the cloud server 120 to store backup data for the terminal the backup data may be managed using the updated data or separately from the updated data.

The backup processing unit 211 may detect the occurrence of an update event in the following cases. The backup processing unit 211 may detect the occurrence of the update event in a case where description of the data stored in the memory unit 230 is changed or is added, a case where the description of the data stored in the memory unit 230 is changed or is supplemented at least a reference number of times, a case where an amount of the changed or added description of the data stored in the memory unit 230 exceeds a reference data amount, a case where a block of the memory unit 230 is changed, a case where the block of the memory unit 230 is changed at least a reference number of times, a case where at least a number of blocks are changed among blocks of the memory unit 230, a case where a reference update time interval is elapsed, or a case where a user request is detected.

In response to a system error of the terminal device 110, the discovery of a virus, or a user request, the recovery processing unit 212 may request the cloud server 120 for backup data and may receive the backup data from the cloud server 120 and thereby restore the terminal device 110. The received backup data may correspond to the latest backup data in which the last updated data is applied. However, the recovery processing unit 212 may receive backup data that is stored at a reference time according to the user request, and thereby restore the terminal device 110 based on the reference time.

The reliability evaluator 213 may evaluate the reliability of an application that a user requests to install. The reliability evaluator 213 may evaluate the reliability using various schemes. Examples of the reliability evaluator 213 evaluating reliability are provided below:

The reliability evaluator 213 may evaluate the reliability of an application by requesting the cloud server 120 for a reliability evaluation of the application, and by receiving a reliability evaluation result of the application from the cloud server 120.

The reliability evaluator 213 may evaluate the reliability of the application by searching the reliability database 240 for the application.

The reliability evaluator 213 may evaluate the reliability of the application by receiving basic information about the application from the application supply server 130, and by determining whether the basic information satisfies a criterion stored in the reference information database 250.

The basic information may include a category of the application, a creator of the application, a sales server of the application, a release date of the application, a permission of the application, and the like. The reference information may include at least one of a reliable category, a reliable creator, a reliable sales server, a reliable reference release date, and a reliable permission. The reference information may be all of the applications created by a reference creator considered to be reliable; all of applications that are created by a reference creator before a reference release date and are sold through a reference sales server may also be considered reliable; all of the applications of a reference category that are sold through a reference sales server may be considered reliable; and applications having a reference permission among applications that are sold through the reference sales server may be considered reliable.

If reference information includes a sales server P, applications that are sold through the sales server P may be considered reliable. If reference information includes a creator A, an application created by the creator A may be considered reliable. If reference information includes a combination of the sales server P and the creator A, an application that is created by the creator A and is sold through the sales server P may be considered reliable.

If the evaluation result of the reliability determination of the application is greater than a threshold value of the reliability evaluator 213, the application downloader 214 may download the application from the application supply server 130.

On the contrary, if the evaluation result of the reliability determination of the application is less than or equal to the threshold value of the reliability evaluator 213, the application downloader 214 may request a virus check of the application from the cloud server 120. If an evaluation result indicating that a virus does not exist in the application is received from the cloud server 120, the application downloader 214 may download the application from the application supply server 130.

The application installer 215 may install the application downloaded from the application downloader 214.

The controller 210 may control an overall operation of the terminal device 110. The controller 210 may perform operations of the backup processing unit 211, the recovery processing unit 212, the reliability evaluator 213, the application downloader 214, and the application installer 215. The controller 210, the backup processing unit 211, the recovery processing unit 212, the reliability evaluator 213, the application downloader 214, and the application installer 215 are depicted as different units to describe the operation of each unit. However, the controller 210 may include at least one processor that is configured to perform the operation or a portion of the operation of each of the processing unit 211, the recovery processing unit 212, the reliability evaluator 213, the application downloader 214, and the application installer 215.

FIG. 3 is a block diagram illustrating the cloud server according to an exemplary embodiment of the present invention.

Referring to FIG. 3, the cloud server 120 may include a controller 310, a backup processing unit 311, a recovery processing unit 312, a virtual apparatus processing unit 313, a reliability evaluator 314, an application downloader 315, a virus check unit 316, a communication unit 320, a backup data storage unit 330, and a reliability database 340. The cloud server 120 may further include a reference information generator 317 and a reference information database 350.

The communication unit 320 may transmit data to and receive data from the terminal device 110 or the application supply server 130 over the network 100. The communication unit 320 may transfer data in a manner substantially similar to communication unit 220. The cloud server transmits data to and receives data from the terminal device 110 or the application supply server 130 through the communication unit 320. The communication unit 320 may be substantially similar to the communication unit 220 of the terminal device and thus description of the communication unit 320 is omitted for brevity.

The backup data storage unit 330 may store backup data and updated data that is received from the terminal device 110. The backup data storage unit 330 may also store a time stamp indicating a time when the backup data and the updated data is received or generated. For example, the backup data storage unit 330 may manage the backup data and the updated data based on a corresponding received time or generated time.

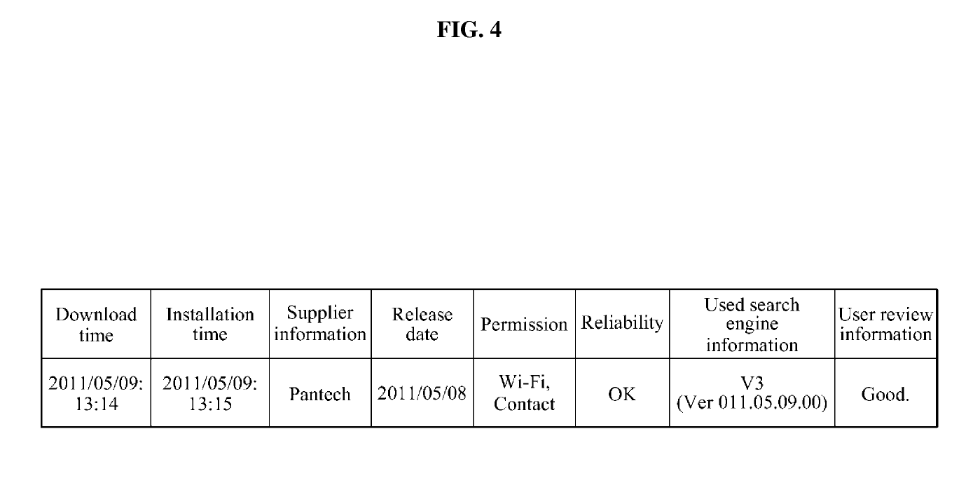

The reliability database 340 may store information about the reliability of each application. The reliability database 340 may be configured as shown in FIG. 4.

FIG. 4 is a diagram illustrating a reliability database according to an exemplary embodiment of the present invention.

Referring to FIG. 4, the reliability database may include a download time, an installation time, supplier information, a release date, a permission, a reliability status, used search engine information, user review information, and the like.

Referring again to FIG. 3, the reference information database 350 may store reference information, i.e., information used to evaluate the reliability of an application. The reference information may include at least one of a reliable category, a reliable creator, a reliable sales server, a reliable reference release date, and a reliable permission.

If backup data generated using all of or a portion of data stored in the memory unit 230 of the terminal device 110 is received, the backup processing unit 311 may store the backup data in the backup data storage unit 330. If the cloud server 120 checks for a virus in the application, the backup data may include data that is used to generate a virtual apparatus 318 capable of performing substantially the same operations as the terminal device 110. The data used to generate the virtual apparatus 318 may include system data of the terminal device 110, an installed application, and update information of the application, and may further include user data, for example, a telephone number, an SMS message, a compressed image file, a moving picture, and the like.

If updated data is received from the terminal device 110, the backup processing unit 311 may store the received updated data in the backup data storage unit 330. The backup processing unit 311 may manage the backup data and the updated data using time stamps included in the backup data and the updated data.

If a request for backup data is received from the terminal device 110, the recovery processing unit 312 may search the backup data storage unit 330 for backup data of the terminal device 110, and may transmit the found backup data to the terminal device 110. The transmitted backup data may correspond to the latest backup data in which the last updated data is applied. However, if a request for backup data stored at a reference time is received from the terminal device 110, the recovery processing unit 312 may transmit backup data corresponding to the reference time using time stamps of the backup data and the updated data stored in the backup data storage unit 330.

If a request for a reliability evaluation of an application is received from the terminal device 110, the reliability evaluator 314 may evaluate the reliability of the application and provide an evaluation result to the terminal device 110. For example, the reliability evaluator 314 may evaluate the reliability of the application through the following schemes:

The reliability evaluator 314 may evaluate the reliability of the application by searching the reliability database 340 for the requested application.

The reliability evaluator 314 may evaluate the reliability of the application by receiving basic information about the application from the application supply server 130, and by determining whether the basic information satisfies a criterion of reference information stored in the reference information database 350. For example, the reference information may correspond to information that is used to evaluate the reliability of the application.

The application downloader 315 may request the application supply server 130 for the application for which a virus check is requested, and may download the application.

The virtual apparatus processing unit 313 may generate the virtual apparatus 318 that performs substantially the same operations as the terminal device 110, based on backup data of the terminal device 110. For example, the virtual apparatus 318 may be an apparatus that is virtually present in the cloud server 120 to perform the operation of a framework or an operating system of the terminal device 110 using a framework or an operating system of the cloud server 120. If the virtual apparatus 318 is generated, the virtual apparatus processing unit 313 may install the downloaded application in the generated virtual apparatus 318. Thus, the virtual apparatus processing unit 313 may initially install the application in the virtual apparatus 318 that is present in the cloud server 120 for a virus check.

The virus check unit 316 may check whether a virus exists in the application installed in the virtual apparatus 318, and may transmit a check result to the terminal device 110. The virus check unit 316 may store the check result about whether a virus exists in the application in the reliability database 340 in order to use the check result as reliability information about the application.

If a virus is discovered in the virtual apparatus 318, the virtual apparatus processing unit 313 may restore the virtual apparatus 318 to an operational state before the application was installed, using the backup data and the updated data that is stored in the backup data storage unit 330 or the terminal device 110.

Even if a virus is not discovered as a result of the virus check, the application may not be installed in the terminal device 110 due to a user's decision, a system error, and the like. If the application is not installed in the terminal device 110 the virtual apparatus processing unit 313 may restore the virtual apparatus 318 to an operational state before the application was installed, using backup data and updated data stored in the backup data storage unit 330, or by receiving backup data from the terminal device 110.

The reference information generator 317 may generate reference information, i.e., information used to evaluate the reliability of the application, based on reliability information stored in the reliability database 340, and may store the generated reference information in the reference information database 350 and transmit the reference information to the terminal device 110.

For example, if a number of applications that are sold through a sales server P and are created by a creator A exceeds a threshold value, for example 50, and if it is determined that a virus does not exist in all of applications that are sold through the sales server P and are created by the creator A, the applications that are sold through the sales server P and are created by the reference information generator 317 may be considered reliable and reference information about the server P and the creator A may be generated. For example, if an application to be installed matches an application that is sold through the sales server P and is created by the creator A, the corresponding application may be determined to be reliable.

The controller 310 may control an overall operation of the cloud server 120. The controller 310 may perform operations of the backup processing unit 311, the recovery processing unit 312, the virtual apparatus processing unit 313, the reliability evaluator 314, the application downloader 315, the virus check unit 316, and the reference information generator 317. The controller 310, the backup processing unit 311, the recovery processing unit 312, the virtual apparatus processing unit 313, the reliability evaluator 314, the application downloader 315, the virus check unit 316, and the reference information generator 317 are depicted as different units to describe the operation of each unit. However, the controller 310 may include at least one processor that is configured to perform the operation or a portion of the operation of each of the backup processing unit 311, the recovery processing unit 312, the virtual apparatus processing unit 313, the reliability evaluator 314, the application downloader 315, the virus check unit 316, and the reference information generator 317.

Hereinafter, a method for backing up and restoring data according to an exemplary embodiment of the present invention will be described with reference to the accompanying drawings. The following methods are described as if performed by the system shown in FIG. 1, but are not limited as such.

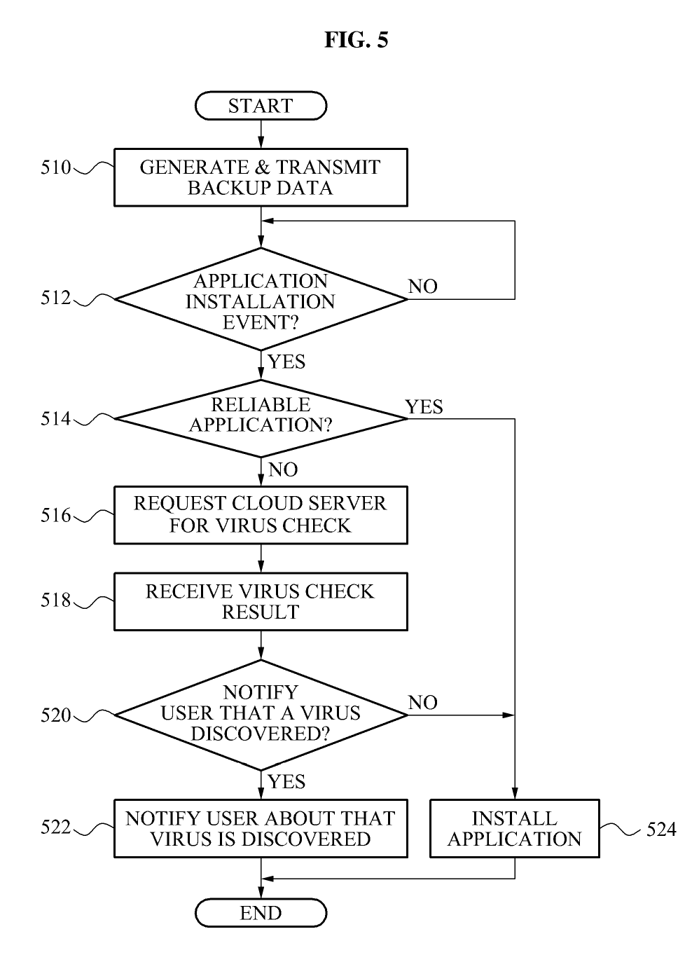

FIG. 5 is a flowchart illustrating a method for installing an application in the terminal device according to an exemplary embodiment of the present invention.

Referring to FIG. 5, in operation 510, the terminal device 110 may generate backup data including data that is used if the cloud server 120 generates a virtual apparatus capable of performing substantially the same operations as the terminal device 110, and may transmit the backup data to the cloud server 120.

In operation 512, the terminal device 110 detects the occurrence of an event to install an application. In operation 514, the terminal device 110 may evaluate the reliability of the application to be installed. For example, the terminal device 110 may transmit an application reliability evaluation request message to the cloud server 120 to evaluate the reliability of the application, and may also evaluate the reliability of the application using information stored in the reliability database 240 or the reference information database 250. The application reliability request message may include basic information about the application.

If the evaluation result of operation 514 determines the application is reliable, the terminal device 110 may install the application in operation 524.

On the contrary, if the evaluation result of operation 514 determines the application is not reliable, the terminal device 110 may request the cloud server 120 for a virus check in operation 516. The terminal device 110 may transmit, to the cloud server 120, a virus check request message including basic information about the application and thereby request the cloud server 120 for a virus check.

In operation 518, the terminal device 110 may receive the virus check result from the cloud server 120.

In operation 520, the terminal 110 may verify whether a virus exists in the application by analyzing the received virus check result.

In operation 522, if a virus is discovered in the verification result of operation 520, the terminal device 110 may notify a user of the terminal device 110 that the virus is discovered.

On the contrary, in operation 524, if a virus is not discovered as a result of operation 520, the terminal device 110 may install the application.

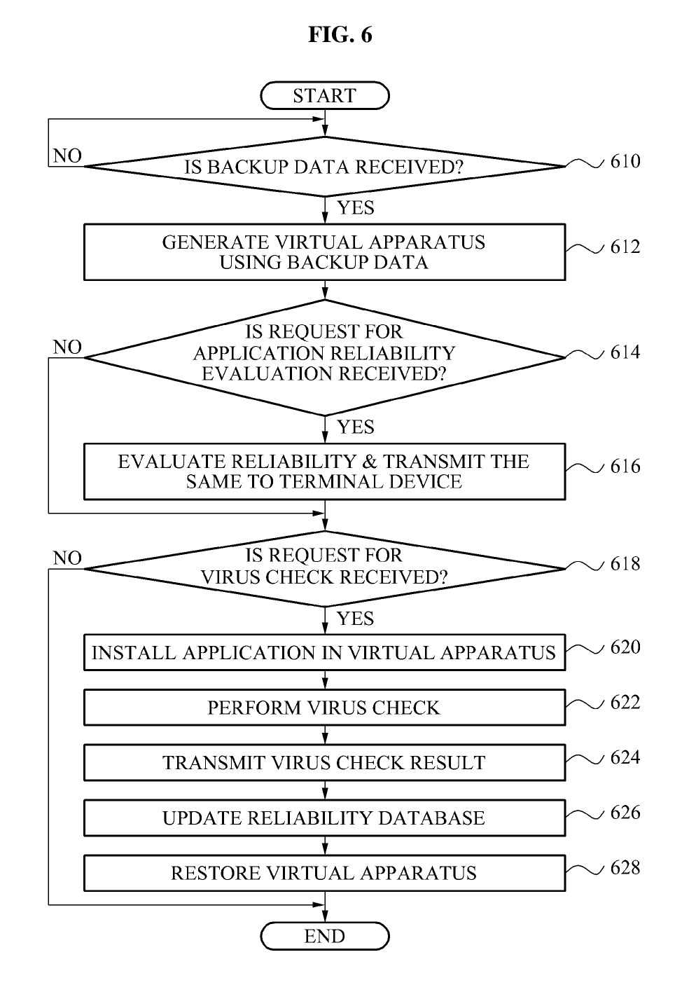

FIG. 6 is a flowchart illustrating a method for checking whether a virus exists in an application in the cloud server according to an exemplary embodiment of the present invention.

Referring to FIG. 6, in operation 610, the cloud server 120 receives backup data from the terminal device 110. In operation 612, the cloud server 120 may generate a virtual apparatus that performs substantially the same operations as the terminal device 110, based on the received backup data.

In operation 614, the cloud server 120 receives a request for reliability evaluation of an application from the terminal device 110. In operation 616, the cloud server 120 may verify the reliability of the application and transmit the verified reliability of the application to the terminal device 110. For example, the cloud server 120 may evaluate the reliability of the application by searching the reliability database 340 for the requested application. The cloud server 120 may evaluate the reliability of the application by receiving basic information about the application from the application supply server 130, and by determining whether the basic information satisfies a criterion of the reference information. If the cloud server 120 does not receive the request for reliability evaluation of the application from the terminal device 110 in operation 614, the cloud server 120 may omit operation 616 and perform operation 618.

In operation 618, the cloud server 120 receives a request for virus check with respect to the application. In operation 620, the cloud server 120 may download the corresponding application from the application supply server 130 and install the downloaded application in the virtual apparatus. In operation 622, the cloud server 120 may perform the virus check in the virtual apparatus. In operation 624, the cloud server 120 may transmit a virus check result to the terminal device 110. In operation 626, the cloud server 120 may update the reliability database 340 with the virus check result. In operation 628, the cloud server 120 may restore the virtual apparatus to a state of operation before the application is installed. The cloud server 120 may omit operation 628 if the application is verified to be installed in the terminal device 110.

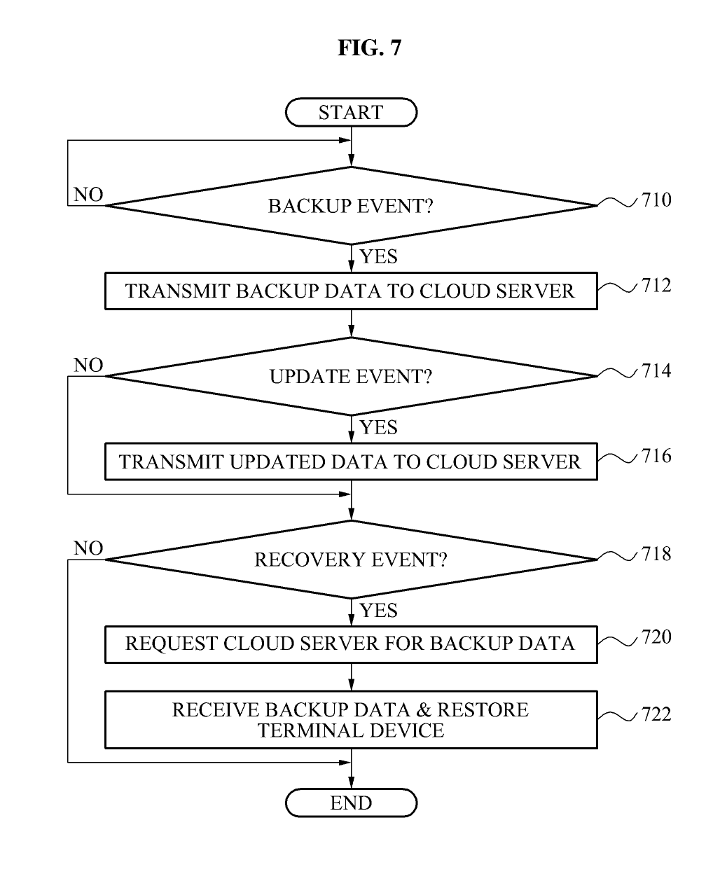

FIG. 7 is a flowchart illustrating a method for backing up and restoring data in the terminal device according to an exemplary embodiment of the present invention.

Referring to FIG. 7, in operation 710, the terminal device 110 detects the occurrence of a backup event. In operation 712, the terminal device 110 may generate backup data using all of or a portion of data stored in the memory unit 230 of the terminal device 110, and may transmit the generated backup data to the cloud server 120. The backup data may include a time stamp indicating a generation time.

In operation 714, the terminal device 110 detects the occurrence of an update event. In operation 716, the terminal device 110 may generate updated data and transmit the updated data to the cloud server 120. The updated data may include a time stamp indicating a generation time. For example, the update event may correspond to a case where description of the data stored in the memory unit 230 is changed or is added, a case where the description of the data stored in the memory unit 230 is changed or is added at least a reference number of times, a case where an amount of the changed or added description of the data stored in the memory unit 230 exceeds a reference data amount, a case where a block of the memory unit 230 is changed, a case where the block of the memory unit 230 is changed at least a reference number of times, a case where at least a number of blocks are changed among blocks of the memory unit 230, a case where a reference update time interval is elapsed, or a case where a user request is detected.

In operation 718, the terminal device 110 detects the occurrence of a restore event, which may be according to a system error of the terminal device 110, a virus discovery, or a user request. In operation 720, the terminal device 110 may request the cloud server 120 for backup data. The requested backup data may be the latest backup data in which the last updated data is applied, or backup data stored at a reference time according to the user request. In operation 722, the terminal device 110 may receive the backup data from the cloud server 120 and restore the terminal device 110.

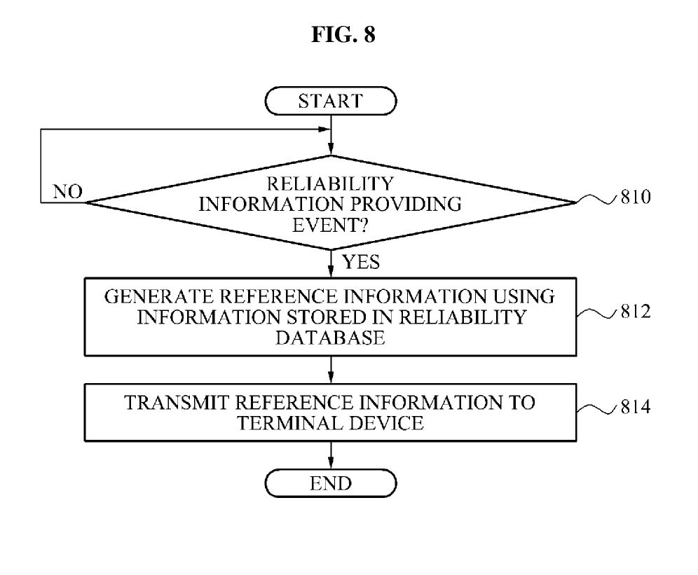

FIG. 8 is a flowchart illustrating a method for generating reference information used according to an exemplary embodiment of the present invention.

Referring to FIG. 8, in operation 810, the cloud server 120 may verify whether a reliability information providing event occurs. The reliability information providing event may occur according to a request of an operator of the cloud server and/or a request of the terminal device 110, at reference time intervals, every time a reference number of applications stored in the reliability database 340 exceeds a threshold value, if a threshold ratio of data stored in the reliability database 340 is updated, and the like.

In operation 810, the reliability information providing event occurs and the reference information generator 317 may analyze reliability information of each application that is stored in the reliability database 340. In operation 812, the reference information generator generates reference information, i.e., information used to evaluate the reliability of the application. For example, if all of applications that are sold through a reference sales server and are created before a reference release date are determined to be reliable, the cloud server 120 may set the analysis of this application result as reference information.

In operation 814, the cloud server 120 may transmit the generated reference information to the terminal device 110.

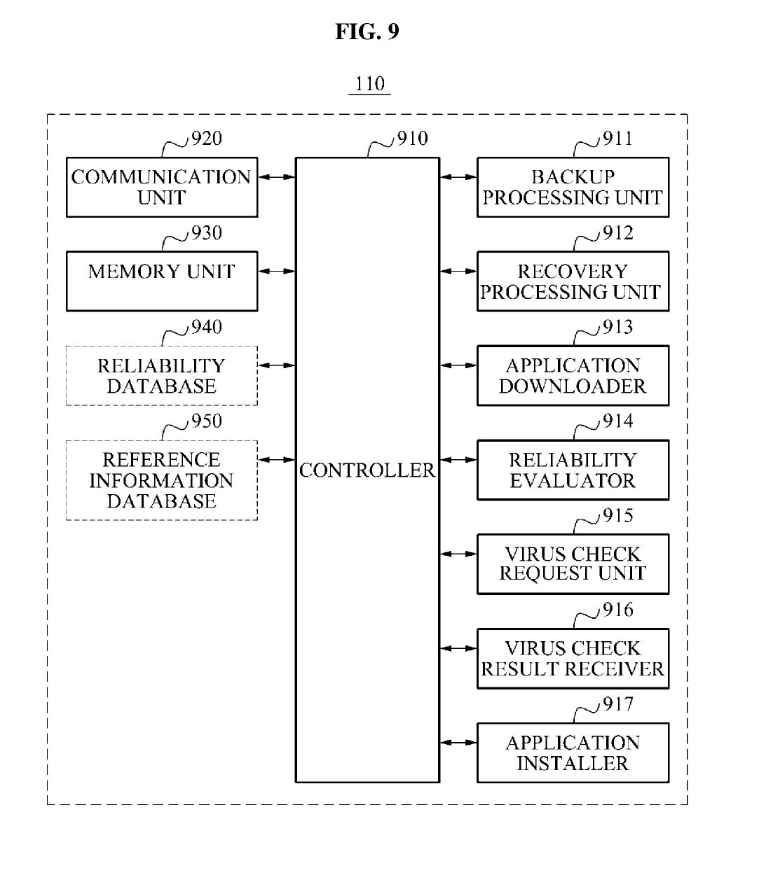

FIG. 9 is a block diagram illustrating a terminal device according to an exemplary embodiment of the present invention.

Referring to FIG. 9, the terminal device 110 may be included in a system to prevent virus damage such as shown in FIG. 1, and include a controller 910, a backup processing unit 911, a recovery processing unit 912, an application downloader 913, a reliability evaluator 914, a virus check request unit 915, a virus check result receiver 916, an application installer 917, a communication unit 920, and a memory unit 930. The terminal device 110 may further include at least one of a reliability database 940 and a reference information database 950.

The backup processing unit 911, the recovery processing unit 912, the communication unit 920, the memory unit 930, the reliability database 940, and the reference information database 950 of FIG. 9 may be substantially the same as these units in FIG. 2 and thus, further detailed description of these units will be omitted.

The application downloader 913 may download, from the application supply server 130, an application requested from a user.

Before installing the downloaded application, the reliability evaluator 914 may evaluate the reliability of the application by using basic information about the application that is included in the downloaded application, or by receiving basic information about the application from the application supply server 130. The basic information may include a category of the application, a creator of the application, a sales server of the application, a release date of the application, a permission of the application, and the like. A method of evaluating the reliability of the application may be substantially the same as the aforementioned method of the reliability evaluator 213 of FIG. 2.

If the evaluation result of the application is determined to be less than or equal to a reference value by the reliability evaluator 914, the virus check request unit 915 may request the cloud server 120 to perform a virus check of the application.

The virus check result receiver 916 may receive a virus check result for the application from the cloud server 120.

If the application installer 917 receives the virus check result indicating that the reliability of the application is greater than a reference value or that a virus does not exist in the application as the evaluation result of the reliability evaluator 914, the application installer 917 may install the downloaded application in the terminal device 110.

On the contrary, if the virus check result indicates that a virus does exist in the application, the application downloader 913 may delete the downloaded application.

According to exemplary embodiments a system may backup data from a terminal device in a cloud server and check for a virus in an application to be installed in the terminal device using the cloud server. By checking the application before installing it, the cloud server may prevent or reduce the risk of virus damage that may occur if an application including a virus is installed in the terminal device. Similarly, if the terminal device experiences virus damage due to installing an application having a virus, the terminal device's memory may be restored from the backup data that is stored on the cloud server.

The exemplary embodiments may be recorded in non-transitory computer-readable media including program instructions to implement various operations embodied by a computer. The media may also include, alone or in combination with the program instructions, data files, data structures, and the like. The non-transitory computer-readable media and program instructions may be those specially designed and constructed for the purposes of the exemplary embodiments, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system to perform a virus check, comprising:
a terminal device to generate backup data corresponding to data stored in the mobile terminal, and to transmit the backup data via a network; and
a cloud server to receive the backup data, to generate a virtual terminal device corresponding to the backup data, to perform a virus check of an application using the virtual terminal device, and to generate a virus check result,
wherein the cloud server performs the virus check of the application in the virtual terminal device in response to a request from the terminal device and transmits the virus check result to the terminal device.

2. The system of claim 1, wherein the terminal device evaluates reliability of the application and in response to a reliability evaluation of the application requests the cloud server to perform the virus check of the application.

3. The system of claim 2, wherein if the reliability evaluation of the application results in a value less than or equal to a threshold value, the terminal device requests the cloud server to perform the virus check of the application.

4. A terminal device, comprising:
a backup processing unit to generate backup data corresponding to data stored in the terminal device;
an application downloader to download an application;
a reliability evaluator to determine reliability of the application;
a communication unit to transmit the backup data and a request for a virus check and to receive a virus check result; and
an application installer to install the application in response to the reliability evaluator determining the application is reliable or in response to the virus check result.

5. The terminal device of claim 4, further comprising:
a reliability database to store reliability information for the application; and
a reference information database to store reference information corresponding to the application.

6. The terminal device of claim 5, wherein the reference information comprises at least one of a reliable category, a reliable creator, a reliable sales server, a reliable reference release date, and a reliable permission.

7. The terminal device of claim 4, wherein the reliability evaluator evaluates the reliability of the application by requesting a reliability evaluation of the application from a cloud server.

8. The terminal device of claim 4, further comprising:
a recovery processing unit to receive backup data and to restore the terminal device based on the received backup data.

9. The terminal device of claim 4, wherein the backup processing unit generates updated data in response to a change in the data stored in the terminal device.

10. A cloud server, comprising:
a backup processing unit to receive backup data from a terminal;
a virtual apparatus processing unit to generate a virtual apparatus corresponding to the backup data;
a reliability evaluator to evaluate reliability of an application in response to a request from the terminal; and
a virus check unit to determine if a virus exists in the application installed in the virtual apparatus and to transmit a result of the virus check to the terminal.

11. The cloud server of claim 10, further comprising:
a reliability database to store reference information;
a reference information generator to generate reference information; and
a reference information database to store generated reference information,
wherein the reliability evaluator determines the reliability of the application based on the reference information.

12. The cloud server of claim 11, further comprising:
a recovery processing unit to transmit backup data to a terminal in response to a request for backup data from the terminal.

13. A method for installing an application in a terminal device, comprising:
generating backup data corresponding to data stored in the terminal device;
transmitting the backup data to a cloud server;
downloading an application in the terminal device;
evaluating reliability of the application in the terminal device;
if the application is considered reliable, installing the application; and
if the application is not considered reliable:
requesting a virus check of the application from a cloud server;
performing the virus check of the application in the cloud server;
if the virus check determines a virus is present, transmitting the result of the virus check to the terminal; and
if the virus check determines a virus check is not present, installing the application in the terminal device.

14. The method of claim 13, wherein performing the virus check of the application in the cloud server, comprises:
generating a virtual apparatus corresponding to the backup data;
installing the application in the virtual apparatus;
determining if a virus exists in the virtual apparatus;
transmitting the result of the determination to the terminal device;
updating a reliability database of the cloud server with the result of the determination; and
restoring the virtual apparatus to a state before the application was installed.

15. The method of claim 13, further comprising:
in response to an update event in the terminal device, transmitting updated data to the cloud server.

16. The method of claim 13, further comprising:
in response to a restoration event:
in the terminal device, requesting the cloud server for the backup data;
in the terminal device, receiving backup data; and
in the terminal device, restoring the terminal device using the received backup data.

17. The method of claim 14, further comprising:
transmitting the reference information to the terminal device.
